(19) United States
(12) Patent Application Publication
(10) Pub. No.: US 2004/0146278 A1
(43) Pub. Date: Jul. 29, 2004

(54) Video recording/reproducing apparatus capable of displaying multiple menus and display method

(76) Inventor: Yun-soo Shin, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/755,330

(22) Filed: Jan. 13, 2004

(30) Foreign Application Priority Data
Jan. 27, 2003 (KR) 2003-5357

(51) Int. Cl. H04N 5/783; H04N 5/781

(52) U.S. Cl. 386/69; 386/95; 386/125

(57) ABSTRACT

A video recording/reproducing apparatus for displaying multiple menus including a plurality of control parts, comprising a main control part for receiving and/or detecting an operation command input by a user, and transmitting the operation command to another control part, a signal processing part for processing a signal under control of each control part, a storing part capable of storing and reading a menu screen under control of the main control part, and a display device capable of displaying a menu screen stored in an output signal of the signal processing part and the storing part. The main control part controls the display device to display multiple menus when a menu screen display request signal is received from an external input device. Accordingly, a graphical user interface (GUI) screen displaying a great deal of information in a single screen while still displaying multiple menus for user's convenience can be provided.

### PRIORITY

This application claims priority under 35 U.S.C. § 119 to an application entitled “Video Recording/Reproducing Apparatus Capable of Displaying Multiple Menus and Display Method Thereof” filed in the Korean Intellectual Property Office on Jan. 27, 2003 and assigned Serial No. 2003-5357, the contents of which are incorporated herein by reference.

### BACKGROUND

1. Field of the Invention

The present invention relates to a video recording/reproducing apparatus capable of displaying multiple menus and a display method, and more particularly, to a video recording/reproducing apparatus having a plurality of menus displayed to enable a user to easily check the menu and change a program, and a display method.

2. Description of the Related Art

Video recording/reproducing apparatus capable of recording a broadcast signal in a recording medium or reproducing the recorded broadcast signal have diverse functions in accordance with the development of broadcast signal digitization and compression technology. These video recording/reproducing devices are currently available in the market as a combination type product in which the independent functions of a first device and a second device are unified. for example, such a video recording/reproducing apparatus can record and reproduce a typical A/V signal.

A unified system into which more than one different devices are integrally connected is called ‘a combination system’ or ‘a combo-system’, and, in short, ‘a combo’.

Such a digital video disk video player (DVDP)/VCR combo-system is multifunctional and therefore, typically, its usage is complicated. For example, the name and operation order of the keys can be difficult for a person who is not skilled in operating the combo-system. Thus, most of the combo-systems have a menu screen (generally referred to as a Graphic User Interface (GUI) screen), displayed as shown in FIGS. 4A and 4B, for a user to operate the system easily. For easy operation of the system, each key that can be operated in each step is displayed on a screen at a predetermined position of the menu screen. In addition, data can be amended through the menu screen.

As shown in FIG. 4B, an upper menu and a lower menu are displayed concurrently for convenient use. The GUI screen shown in FIGS. 4B and 4C, is a multiple menu display 400 and divided into an upper part 410, a middle part 420, and a lower part 430. The upper part 410 is used for displaying a message at a predetermined position providing information on the menu screen relating the menu the user has currently enabled. The message ‘COMBO Initial Setup’ indicates that the current screen is an initial setup menu related to a combo-system. The middle part 420 is divided into a first domain area 421 for displaying a menu folder (hereinafter called a “first domain” area) showing an upper folder, and a second domain area 422 for displaying a lower menu folder (hereinafter called a “second domain” area) showing a lower menu of the corresponding folder. The lower part 430 displays information on the key usage of a remote controller 200 corresponding to the use of a multiple menu display 400.

There is no problem when “SETUP” is selected on a menu selection bar 450 from the multiple menu display by operating a key of the remote controller 200 as shown in FIG. 4B, as the information shown on the second domain area 422 displays all lower menus belonging to “SETUP”. However, when “PROG” is selected on the menu selection bar 450, as shown in FIG. 4C, all the information may not be displayed due to limited display space, as there is a lot of information to be displayed on the second domain area 422. Since the first domain area 421 basically occupies predetermined space, the second domain area is relatively smaller to display all the information pertaining to the selected menu item. This problem becomes more serious when greater amounts of information is to be displayed in the limited space due to the use of an On Screen Display (OSD) chip, which has a larger font.

### SUMMARY OF THE INVENTION

An object of the present invention is to substantially solve at least the above problems and/or disadvantages and to provide at least the advantages described below. Accordingly, it is an object of the present invention to provide a video recording/reproducing apparatus for displaying multiple menus, comprising: a main control part for receiving and/or detecting an operation command input by a user, and transmitting the operation command to another control part, and a signal processing part for processing a signal under control of the each said control part. The video recording/reproducing apparatus further comprises a storing part capable of storing and reading a menu screen under control of the main control part, and a display device capable of displaying a menu screen stored in an output signal of the signal processing part and the storing part.

It is a further object of the present invention to provide a method employing a video recording/reproducing apparatus for displaying multiple menus, comprising the steps of displaying a multiple menu screen, wherein the multiple menu screen comprises an upper part, a middle part, and wherein the middle part is divided into a first domain and a second domain, and a lower part and selecting a menu folder from at least one or more menu folders located in the first domain. The method for displaying multiple menus further comprises displaying related lower menus corresponding to the selected menu folder if the selected menu folder is not the program menu folder and displaying information related to at least one or more preset programs in the second domain.

It is still another object of the invention to provide an additional method employing a video recording/reproducing apparatus for displaying multiple menus, comprising the steps of receiving and/or detecting an operation command input by a user at a main control part, and transmitting the operation command to another control part, processing a signal under control of the each said control part at a signal processing part and storing and reading a menu screen under control of the main control part at a storing part. The method employing a video recording/reproducing apparatus for displaying multiple menus further comprises displaying a menu screen stored in an output signal of the signal processing part and the storing part in a display device.

### BRIEF DESCRIPTION OF THE DRAWINGS

The above aspect and other features of the present invention will become more apparent by describing in detail an illustrative, non-limiting embodiment thereof with reference to the attached drawings, wherein:

FIG. 1 is a view showing a system in which a video recording/reproducing apparatus displaying multiple menus according to an embodiment of the present invention is employed;

FIG. 2 is a block diagram schematically showing a video recording/reproducing apparatus displaying multiple menus of FIG. 1;

FIG. 3 is a plane view schematically showing a remote controller of FIG. 1;

FIGS. 4A through 5B show multiple menu display screens; and

FIG. 6 is a flow chart for illustrating a display method of multiple menu screens.

### DETAILED DESCRIPTION OF THE PREFERRED EMBODIMENT

Hereinafter, a video recording/reproducing apparatus displaying multiple menus and a display method thereof according to an embodiment of the present invention will be described in greater detail with reference to the accompanying drawings.

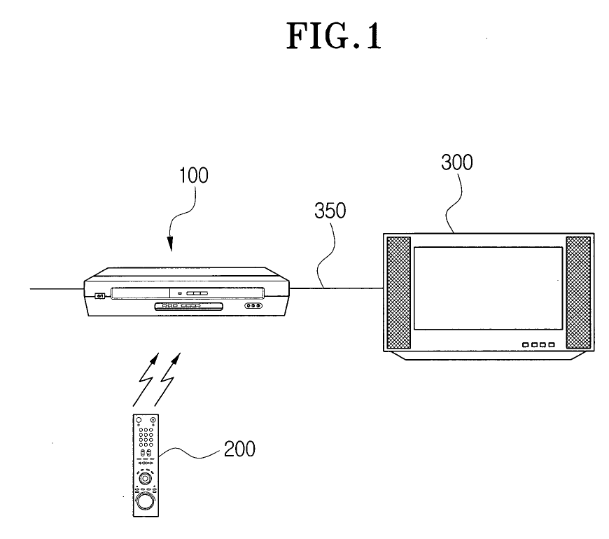

FIG. 1 is a view showing a system in which a video recording/reproducing apparatus displaying multiple menus is employed.

Referring to FIG. 1, a typical video recording/reproducing apparatus 100 is connected with a television 300, which is a display device, by transmission cable 350.

Such a video recording/reproducing apparatus 100 processes a signal received from a remote controller 200 as an external input device, and transmits display information to the television 300. The term “external input device” as used herein applies not only to the remote controller 200, which transmits a wireless signal, such as an infrared ray, but also to other input devices, such as a wired keyboard.

The video recording/reproducing apparatus 100 is structured to receive at least one video signal provided by various image sources. Examples of image sources can include other medium such as terrestrial television broadcasting, satellite broadcasting, cable inlet wire, computer cable, or modem cable which can transmit a signal.

The embodiments of the present invention which will be described below can be applied to a video recording/reproducing apparatus 100 structured to receive at least one video source such as a satellite dish, local cable, Digital Broadcast Source (DBS), a general antenna, internet, other computer source, a camcorder, a disk player, and a settop box.

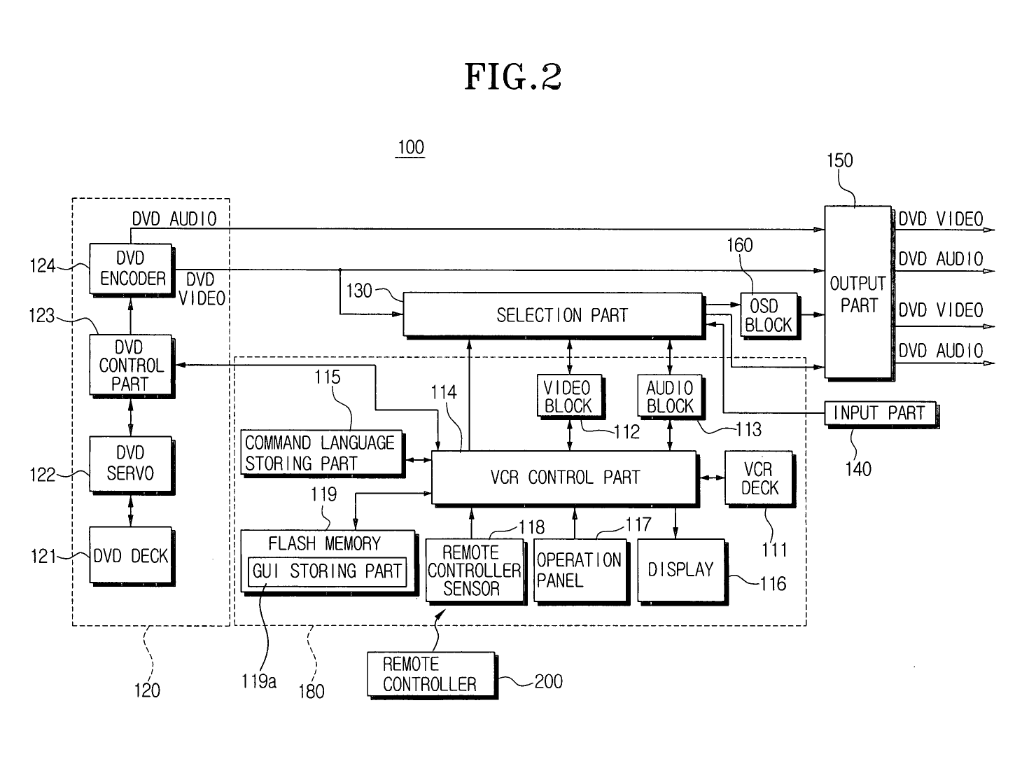

FIG. 2 is a schematic block diagram of the video recording/reproducing apparatus 100 illustrated in FIG. 1.

In particular, FIG. 2 is a schematic block diagram showing the inner structure of the video recording/reproducing apparatus 100, (also referred to as a combo system, or more particularly, a DVDP/VCR combo system 100), which can function both as a DVDP and a VCR.

The DVDP/VCR combo system 100 comprises a VCR part 180 which functions as a general VCR, a DVDP portion 120 which functions as a general DVDP, a selection part 130 for selecting signals input from the VCR part 180 and DVD part 120, and an external signal input part 140 for providing signals input from an external device, such as a camcorder, to the selection part 130. The DVDP/VCR combo system 100 further comprises an output part 150 for providing signals output from the VCR part 80 and the DVDP part 120 to peripheral devices, such as a television and an amplifier, and an On-Screen Display (OSD) block 160, which adds an OSD function to a video signal output from the VCR part 180 and the DVDP part 120.

The VCR part 180 comprises a VCR deck 111 for recording a signal on magnetic tape, or reproducing a signal recorded on magnetic tape, a signal processing part (referring collectively to a video block 112, and an audio block 113) for processing video and audio signals recorded or reproduced with respect to the VCR deck 111. The VCR part 180 further comprises a VCR control part 114 for controlling overall operation of the VCR deck 111, the video block 112, and the audio block 113. In addition, the VCR part 180 comprises a display 116 for displaying information regarding the operation status and mode of the VCR part 180 for a user, an operation panel 117 for receiving various types of commands from a user, and a remote controller sensor 118 for receiving various types of commands from a user through the remote controller 200.

In addition, the VCR part 180 comprises a command language storing part 115 for storing various types of command languages. The command language storing part 115 stores a code with respect to various types of operation commands necessary for the operation of the VCR part 180 and the DVDP part 120 therein, and also stores information on whether each operation command is a command language used in only the VCR part 180 or used in both the VCR part 180 and the DVDP part 120. The VCR control part 114 compares the command language stored in the command language storing part 115 and the command language input from the remote controller sensor 118 or the operation panel 117, thereby determining whether the input command language is used exclusively in either the DVDP part 120, or the VCR part 180, or used in both the DVDP part 120 and the VCR part 180.

The DVDP part 120 comprises a DVD deck 121, a DVD servo 122, a DVD control part 123, and a DVD encoder 124. The DVD deck 121 reads data recorded in a DVD in order to reproduce the video signal stored on the DVD, and the DVD servo 122 controls the location and velocity of the DVD deck 121. The DVD encoder 124 receives data read by the DVD deck 121 through the DVD control part 123, and outputs DVD video and audio data. The DVD control part 123 controls the overall operation of the DVD deck 121, the DVD servo 122, and the DVD encoder 124.

The VCR control part 114 and the DVD control part 123 are connected with each other for mutually transmitting and receiving a command language.

The selection part 130 has, as an input, the output from the DVD encoder 124, the video block 112 and the audio block 113, and a signal from the input part 140. The selection part 130 makes a selection on a signal controlled and input by the VCR control part 114 and the DVD control part 123. The output of the selection part 130 is input into the OSD block 160 and then into the output part 150.

The OSD block 160 adds an OSD function to a signal input from the selection part 130.

The output part 150 receives a signal from the DVD encoder 124, the selection part 130, and the OSD block 160, and outputs a signal with respect to DVD video, DVD audio, VCR video, and VCR audio. The output part 150 is connected with peripheral devices such as a television or an audio system and accordingly video and audio are output from the peripheral devices.

The external signal input part 140 is connected to the selection part 130 and transmits a signal input from the outside to the selection part 130. A signal output terminal of the various external devices, such as a camcorder, is connected to the external signal input part 140. Therefore, a signal recorded in the external devices can be transmitted to the DVDP/VCR combo system 100 through the external signal input part 140, and the signal can be recorded in magnetic tape using the VCR part 180 or reproduced through a television.

A flash memory 119 stores various types of programs with respect to the execution of the functions of the DVD control part 123 and the VCR control part 114. A Graphic User Interface (GUI) storing part 119a, which is part of flash memory 119, stores a program according to an embodiment of the present invention for storing a menu screen and displaying the menu screen through an external display device.

When the video recording/reproducing apparatus 100 structured as above is turned on, the VCR control part 114 loads an operating system from the flash memory 119, and at the same time, transmits corresponding drive data to the DVD control part 123. After that, the video recording/reproducing apparatus 100 is controlled by pressing the operation button of the operation panel 117 and the remote controller 200.

Hereinafter, a method of displaying multiple menus by the VCR control part 114 based on the key selection on the remote controller 200 using the video recording/reproducing apparatus 100 structured as above will be described in detail. In an embodiment of the present invention, the VCR control part 114 is described as a main control part for controlling the system: however, the system may also be controlled by the DVD control part 123, or a main control part (not shown) may be separately disposed therein for controlling the VCR control part 114 and the DVD control part 123.

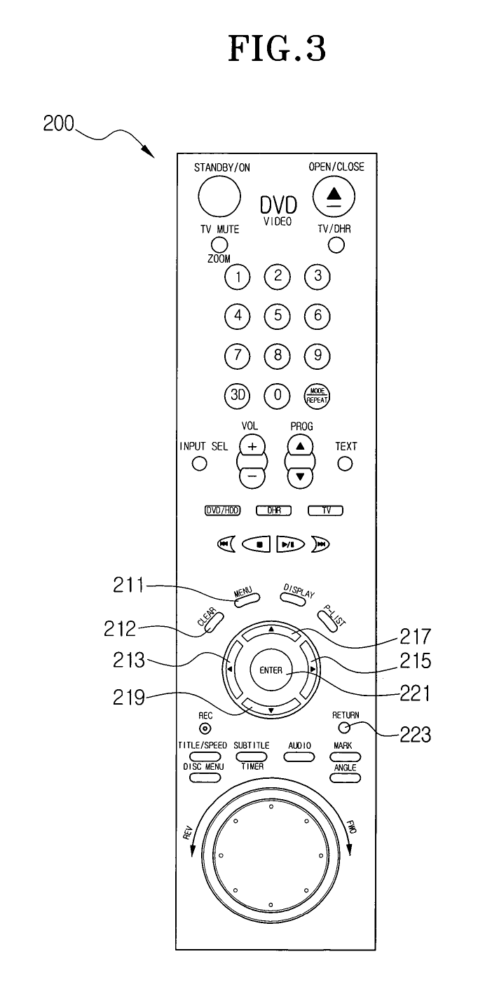

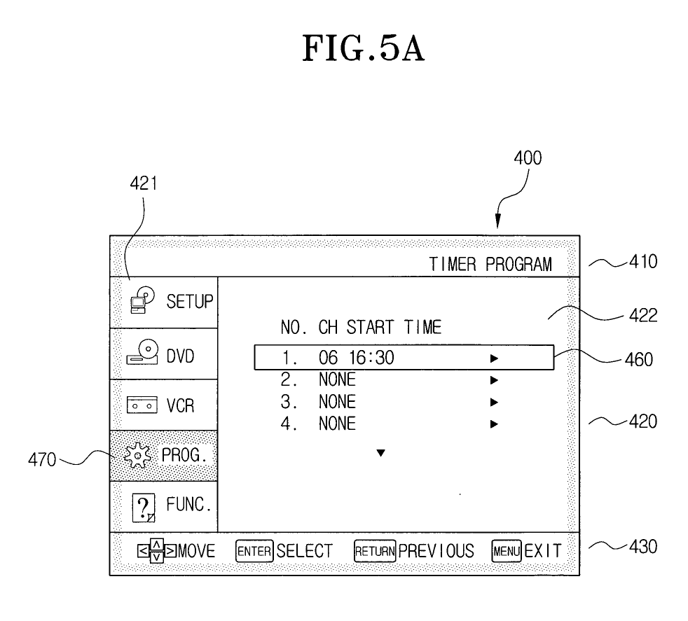

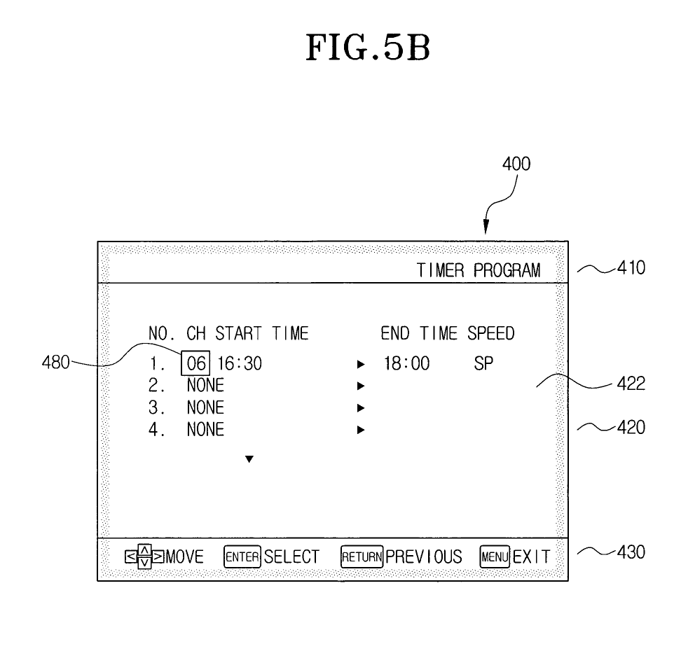

The major functions in connection to the GUI screen operation will be described in reference to FIG. 3. FIG. 3 illustrates the remote controller 200 which is an external input device of the video recording/reproducing apparatus 100 according to an embodiment of the present invention. An example of the GUI screen can include a multiple menu display 400 (FIGS. 5A and 5B). The GUI screen is a graphic screen provided for the user's convenience.

The GUI screens can be realized by using the OSD block 160.

In FIG. 3, the reference numeral 211 is a menu key used for loading and closing the GUI screen, and reference numerals 213, 215, 217 and 219 are left, right, up, and down direction keys used for moving a cursor with respect to a listed menu classified on the GUI screen. The reference numeral 221 is an enter key used for selecting a menu, and 223 is a return key used for returning back to the previous screen.

Other keys are for operating the video recording/reproducing apparatus 100 and the television 300, and a detailed description of each key will be omitted.

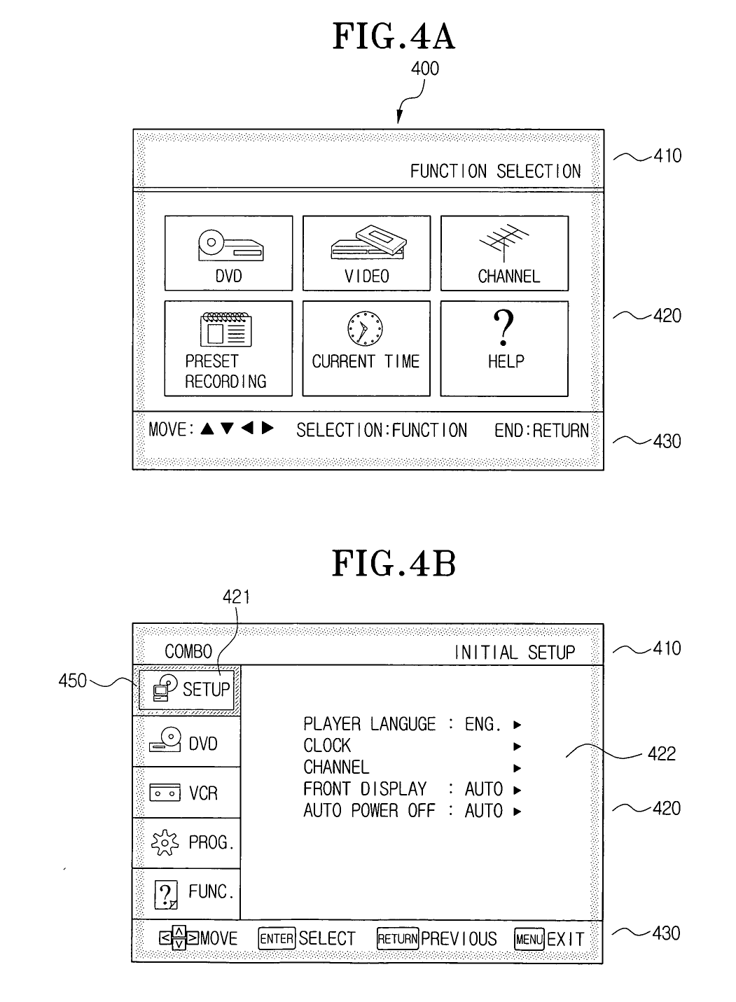

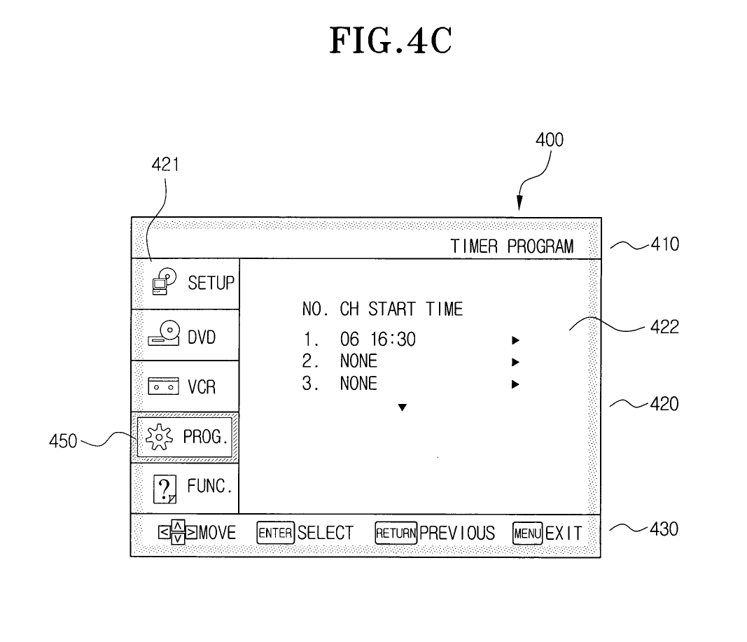

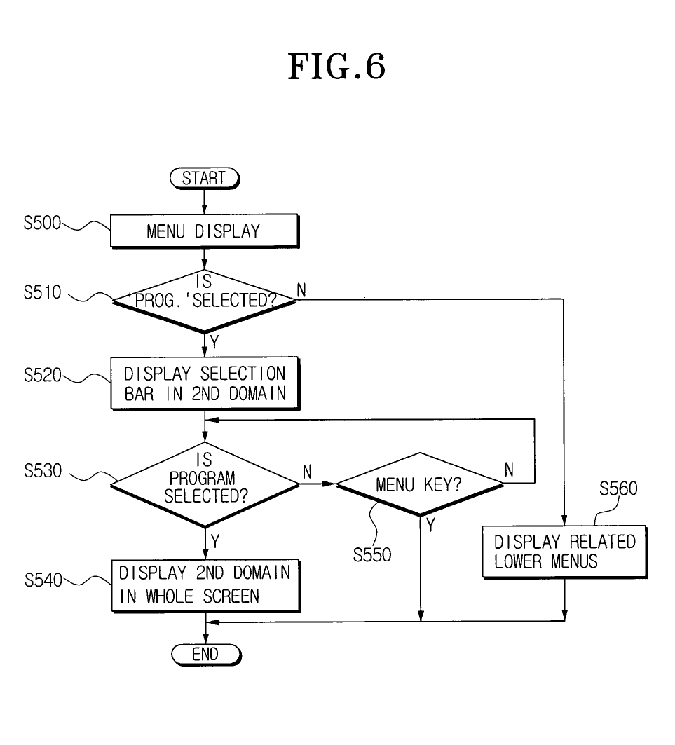

FIG. 5A shows a screen displayed when the upper menu “PROG” is selected from the first domain area shown in FIG. 4B. FIG. 5B illustrates another exemplary embodiment in which the detailed screen when a first program 460 is selected from the second domain area of FIG. 5A is displayed as a whole screen. FIG. 6 is a flow chart of a method for illustrating a lower menu screen into a whole screen from the multiple menu display screen in accordance with an embodiment of the present invention.

Referring now to FIG. 6, while viewing data reproduced by the video recording/reproducing apparatus 100 on the television 300, when the menu key 211 is selected from the remote controller 200, the VCR control part 114 reads the GUI screen stored in the flash memory 119, and displays a multiple menu screen such as the screen shown in FIG. 4B on the television 300 (Step S500).

According to an embodiment of the present invention, the multiple menu display 400 is divided into an upper part 410, a middle part 420, and a lower part 430. The upper part 410 is used for displaying a message for describing the menu screen, the middle part 420 is divided into a first domain area 421 for displaying a menu folder (hereinafter called a “first domain” area) showing an upper folder, and a second domain area 422 for displaying a lower menu folder (hereinafter called a “second domain” area) showing a lower menu of the corresponding folder, and the lower part 430 displays information on the key usage of a remote controller 200 corresponding to the use of a multiple menu display 400.

The menu selection bar 450 displayed in the first domain area 421 is set to have “SET UP” as the highest menu and the second domain area 422 is set to display a lower menu folder in connection to the “SET UP” menu.

If the menu selection bar 450 is moved by the left, right, up, and down direction keys 213, 215, 217, 219 on the remote controller 200, the content of the corresponding lower menu is displayed in the second domain area 422. As shown in FIG. 4C, when the menu selection bar 450 is moved to “PROG” in the first domain area 421, a program number, a broadcasting channel and commencement time related to preset recording are displayed in the second domain area 422. In addition, since it is not possible to display all information, arrow displays “≃” are used to indicate that there is still more information to be displayed.

As shown in FIG. 4C, when the menu selection bar 450 is positioned on “PROG” and the “ENTER” key is pressed on the remote controller 200 for setting/changing an individual program in the “PROG” menu displaying step (Step S510), information related to the preset program is displayed in the second domain area 422 as shown in FIG. 5A (“Yes” path from decision Step S510). In addition, the selected menu bar 470 is distinguished from the non-selected menu bar 450 by highlighting the whole menu bar “PROG” as shown in FIG. 5A. More preferably, the second domain selection bar 460 can be automatically set on the highest program, that is, program number “1” in FIG. 5A, for a user to easily make a selection (Step S520).

When the second domain selection bar 460 shown in FIG. 5a is moved by the left, right, up, and down direction keys 213, 215, 217, 219 on the remote controller 200 while indicated, the menu selection bar 450 in the first domain is fixed, and the second domain selection bar 460 is moved.

When “ENTER” key 221 is pressed with the second domain selection bar 460 positioned on program number “1” on the screen shown in FIG. 5A (Decision Step S530), the program number “1” is selected (“Yes” path from decision Step S530). Consequently, the VCR control part 114 reads out a screen as shown in FIG. 5B from the GUI storing part 119a of the flash memory 119, and displays the screen on the television 300 (Step S540), on substantially the entire menu screen.

Accordingly, complex information can be displayed in a single screen by displaying second domain data in the first domain area 421.

The reference numeral 480 denotes a set change bar provided for enabling a user to select a desired item and set or change the appropriate information.

If a user selected a menu other than “PROG” in Step S500 (“No” path from decision step S510), a corresponding lower menu is displayed and ended (Step S560).

In addition, if a user does not select a program in decision Step S530 (“No” path from decision step S530), it is determined whether the input key is the “MENU” key 211 of the remote controller 300 (Decision Step S550). If the input key is the “MENU” key 211 (“Yes” path from decision Step S550), the program is ended and if not (“No” path from decision Step S550), the system awaits until the program is selected.

According to the video recording/reproducing apparatus 100 and the display method of an embodiment of the present invention, a GUI screen displaying a great deal of information in a single screen, while still displaying the required multiple menus for user's convenience is provided.

Although an embodiment of the present invention has been described, it will be understood by those skilled in the art that the present invention should not be limited to the described embodiment, but various changes and modifications can be made within the sprit and scope of the present invention as defied by the appended claims.

1. A video recording/reproducing apparatus for displaying multiple menus, comprising:
a main control part for receiving and/or detecting an operation command input by a user, and transmitting the operation command to another control part;
a signal processing part for processing a signal under control of the each said control part;
a storing part capable of storing and reading a menu screen under control of the main control part; and
a display device capable of displaying a menu screen stored in an output signal of the signal processing part and the storing part.

2. The video recording/reproducing apparatus according to claim 1, wherein the main control part controls the display device to display multiple menus when a menu screen display request signal is received from an external input device.

3. The video recording/reproducing apparatus according to claim 1, wherein the main control part comprises a VCR control part.

4. The video recording/reproducing apparatus according to claim 1, wherein the main control part comprises a DVD control part.

5. The video recording/reproducing apparatus according to claim 1, wherein the signal processing part comprises:
a video block, for processing video signals; and
an audio block for processing audio signals.

6. The video recording/reproducing apparatus according to claim 1, wherein the storing part comprises:
a graphic user interface storing part which stores a program for storing a menu screen and displaying the menu screen through the display device.

7. A method employing a video recording/reproducing apparatus for displaying multiple menus, comprising:
displaying a multiple menu screen, wherein the multiple menu screen comprises an upper part, a middle part, the middle part divided into a first domain and a second domain and a lower part;
selecting a menu folder from at least one or more menu folders located in the first domain;
displaying related lower menus corresponding to the selected menu folder if the selected menu folder is not the program menu folder; and
displaying information related to at least one or more preset programs in the second domain.

8. The method for displaying multiple menus for controlling a video recording/reproducing apparatus according to claim 7, wherein the menu folders of the first domain comprises at least one of the following:
a setup menu folder;
a DVD menu folder;
a VCR menu folder;
a program menu folder; and
a function menu folder.

9. The method for displaying multiple menus for controlling a video recording/reproducing apparatus according to claim 7, wherein lower part displays information on the key usage of a remote controller corresponding to the use of a multiple menu display.

10. The method for displaying multiple menus for controlling a video recording/reproducing apparatus according to claim 7, further comprising:
determining whether one of the at least one or more preset programs in the second domain has been selected; and
displaying on substantially the entire multiple menu screen information corresponding to the selected preset programs if one of the at least one or more preset programs in the second domain has been selected; and
determining whether a user has selected a menu command.

11. The method for displaying multiple menus for controlling a video recording/reproducing apparatus according to claim 10, further comprising:
determining whether one of the at least one or more preset programs in the second domain has been selected if the user has not selected a menu command.

12. The method for displaying multiple menus for controlling a video recording/reproducing apparatus according to claim 10, wherein the information corresponding to the selected preset program comprises at least one of the following:
a program number;
a broadcasting channel;
a commencement time;
an end time; and
a speed.

13. A method employing a video recording/reproducing apparatus for displaying multiple menus, comprising:
receiving and/or detecting an operation command input by a user at a main control part, and transmitting the operation command to another control part;
processing a signal under control of the each said control part at a signal processing part;
storing and reading a menu screen under control of the main control part at a storing part; and
displaying a menu screen stored in an output signal of the signal processing part and the storing part in a display device.

14. The method for displaying multiple menus according to claim 13, further comprising:
controlling the display device by the main control part to display multiple menus when a menu screen display request signal is received from an external input device.

15. The method for displaying multiple menus according to claim 13, wherein the main control part comprises a VCR control part.

16. The method for displaying multiple menus according to claim 13, wherein the main control part comprises a DVD control part.

17. The method for displaying multiple menus according to claim 13, further comprising:
processing video signals in a video block which is part of the signal processing part; and
processing audio signals in an audio block which is part of the signal processing part.

18. The method for displaying multiple menus according to claim 13, further comprising:
storing a program for storing a menu screen in a graphic user interface storing part which is part of the storing part; and
storing a program for displaying the menu screen through the display device screen in a graphic user interface storing part which is part of the storing part.
